(19) United States
(12) Patent Application Publication
(10) Pub. No.: US 2015/0371289 A1
(43) Pub. Date: Dec. 24, 2015

(54) METHOD FOR PROVIDING INTEGRATED MANAGEMENT SERVICE FOR CREATIVE PRODUCTS IN CULTURAL ARTS REFLECTING NEEDS OF REQUESTER

(71) Applicant: Chang Joung Shin, Nonsan-si (KR)

(72) Inventor: Chang Joung Shin, Nonsan-si (KR)

(21) Appl. No.: 14/840,395

(22) Filed: Aug. 31, 2015

Related U.S. Application Data
(63) Continuation of application No. PCT/KR2014/003972, filed on May 2, 2014.

(30) Foreign Application Priority Data
May 16, 2013 (KR) 10-2013-0055783

(51) Int. Cl. G06Q 30/02

(52) U.S. Cl. CPC G06Q 30/0278

(57) ABSTRACT

A method for providing the integrated management service for the creative products in the cultural arts reflecting the needs of the requester includes the steps of: (i) receiving, as an input, basic information and survey information in which the needs of the requester are reflected, from the requester who has appreciated or is to appreciate a particular creative product; (ii) classifying a level of the requester on the basis of the needs of the requester included in the input basic information and survey information, and registering a result of the classification in a database together with the basic information, the survey information, and creative product identification information on the creative product; and (iii) providing a selective and limited service according to the classified level of the requester, when the requester requests detailed information on the particular creative product.

### REFERENCE TO RELATED APPLICATIONS

This is a continuation of pending International Patent Application PCT/KR2014/003972 filed on May 2, 2014, which designates the United States and claims priority of Korean Patent Application No. 10-2013-0055783 filed on May 16, 2013, the entire contents of which are incorporated herein by reference.

### FIELD OF THE INVENTION

The present invention relates to a method for providing an integrated management service for creative products in cultural arts of reflecting needs of a requester and more particularly, to a method for providing an appreciation information and estate appraisal service on the creative products in cultural arts and an online-self creator management interlocking system through the same.

### BACKGROUND OF THE INVENTION

In a variety of fields related to a culture and art, various peoples such as creators or appreciators of the culture and art, sellers, buyers, curators, or consultants etc. are involved in cultural and artistic creations and carry out their role in different areas.

However, many fields related to the culture and art has been generally depressed owing to the income difference between classes and the regional difference in the enjoyment opportunity of the culture and art engaged with the socially and economically ocular changes at home and abroad. Above all, in the art market, since the positive efforts and the integrated system capable of involving all of the creators, appreciators, an buyers have been lacked and there is no general and universal criteria for the appreciation and the assessment of the value of the creative products work, such a phenomenon has been more deepened. Particularly, in the cultural and art market, there is a distinctiveness that cannot be simplified with the principle of general goods market. The reason is that it is impossible to perform a simple comparison so as to fix the aesthetic value between the creative products as the goods.

Recently, in even the principle of supply and demand, the needs of consumers in general merchandise are not simple. The trends thereof are changing by means of the manners such as symbols or tastes, values of self-realization, and exchange of the meanings. Moreover, the evaluation on the creative products in cultural arts demands a simple lover or investment as well as an aesthetic value for the self-realization.

In addition, the creators had played a vaguely creative work without the information about the needs of the universal appreciator or buyer in their production process. However, the creators also want to strongly know the needs of the appreciator and the buyers on his creative products for the creative activities thereof.

### SUMMARY OF THE INVENTION

Accordingly, the present invention has been made to solve the above-mentioned problems occurring in the prior art, and a object of the present invention is to provide a method for providing an integrated management service for creative products in cultural arts reflecting needs of a requester in that an appreciation information and an estate appraisal information on the creative products are provided to the requester and an assessment or a response information of the requester (for example, customer) are continuously updated, so that the creator can reflect them in his later work production through the accumulated assessments or the visiting history of the customers and it can update his new information personally.

Another object of the present invention is to provide a method for providing an integrated management service for creative products in cultural arts reflecting needs of a requester in that, after the information is inputted from the customer who has appreciated or is to appreciate the creative product to be stored in a database, if detailed information on the particular creative product is requested, it provides a customized or a selective and limited appreciation information service of reflecting the needs thereof based on the database, a healing information service, an estate appraisal service, or a self-consulting service on the creative products.

According to one aspect of the present invention so as to accomplish these objects, there is provided to a method for providing the integrated management service for the creative products in the cultural arts reflecting the needs of the requester according to an embodiment of the present invention including the steps of (i) receiving, as an input, basic information and survey information in which the needs of the requester are reflected, from the requester who has appreciated or is to appreciate a particular creative product; (ii) classifying a level of the requester on the basis of the needs of the requester included in the input basic information and survey information, and registering a result of the classification in a database together with the basic information, the survey information, and creative product identification information on the creative product; and (iii) providing a selective and limited service according to the classified level of the requester, when the requester requests detailed information on the particular creative product.

At this time, a survey information related to the creative products comprises an information related to an interest, a purpose, and a preference level on the creative products and an information of reflecting the needs of the requester who has appreciated or is to appreciate the creative product.

Also, where a level of the requester is a “level low”, the selective and limited service is a service of providing only the appreciation information to the requester.

Also, where a level of the requester is a “level high”, the selective and limited service is a service of providing at least one of an appreciation information on the creative product, an estate appraisal information on the creative product, and an appreciating treatment information.

At this time, the appreciating treatment information is an information for healing the caught psychological/emotional state after the psychological/emotional state of the appreciator is caught by analyzing the accumulated preference or needs information.

At this time, the estate appraisal information is any one of (1) standard type estate appraisal information, (2) investment value type estate appraisal information, and (3) holding value type estate appraisal information for the purpose of the proper selling/buying time and the enjoyment so as to buy cheaply undervalued creative products and sell over market sell when the value has been increased in the future depending on the needs of the requesters.

At this time, (1) standard type estate appraisal information is the estate appraisal information with a view to trade, that is buy it for the enjoyment of the corresponding creative product, (2) investment value type estate appraisal information is the estate appraisal information for the purposes of the expected return on investment such as bid/public sale/auction etc. so as to avoid transient fads seen outwardly, and (3) the holding value type estate appraisal information is the estate appraisal information of evaluating the enjoyment value for self-realization and the future value of the corresponding work owned by the individuals, the organizations, the institutions, and the public facilities etc. through the analysis of the price trend and the current status of the work and the analysis of the activity trends of the authors, so as to determine the disposal and sale period later.

Also, there is provided to a method for providing the integrated management service for the creative products in the cultural arts reflecting the needs of the requester according to an embodiment of the present invention further including the steps of: constituting a graded creative product database by giving a creator code information to the creator of the creative product, assigning a creative product identification information on the corresponding creative product, and storing them in a database.

At this time, the creator code number is an information for identifying the creator and another creator and the creative product identification information is an information for identifying the corresponding creative product and the other creative product, the creator code number and the creative product identification information including an unique number, an unique code, an unique identification information, an image pattern, and a bar code.

Also, the graded creative product database is classified and constituted by level according to a background or an year of the creative product, activities of the creator, a history information, a survival or age of the creator, a material used in the creative product, a size or a weight of the creative product, a labor time required to complete the creative product, an issue and creativity of the creative product, a production speed of the creative product, a popularity, a rarity, an uniqueness (degree of similarity works), a sales rate of the creative product, a preference or an evaluation of the appreciator, and a comprehensive evaluation of the expert etc.

Also, there is provided to a method for providing the integrated management service for the creative products in the cultural arts reflecting the needs of the requester according to an embodiment of the present invention further including steps of performing (i) step through (iii) step repeatedly; and providing a visiting history of reflecting assessments or needs of the requesters accumulated by the repeated steps by linking with the a self-consulting information for creator.

Also, there is provided to a method for providing the integrated management service for the creative products in the cultural arts reflecting the needs of the requester according to an embodiment of the present invention further including the steps of providing a self-consulting service so as to reflect the information of reflecting the assessments and the needs of the requester accumulated in the database in his work production, if a service is requested from an author of creating the particular creative product.

Also, there is provided to a method for providing the integrated management service for the creative products in the cultural arts reflecting the needs of the requester according to an embodiment of the present invention further including the steps of providing an updated database to the requester by updating contents or new information directly updated by the creator in the database by means of the self-consulting service provided to the creator.

According to the present invention, it can provide the customized or the selective appreciation information service or the estate appraisal service to the customers and it can provide the self-consulting information to the creators, so that the creator can reflect them in his later work production through the accumulated assessments or the visiting history of the customers, thereby meeting all of the needs of the customer and the creator.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram illustrating a system for applying a method for providing an integrated management service for creative products in cultural arts reflecting needs of a requester according to an embodiment of the present invention;

FIG. 2 is a block diagram illustrating a configuration of an integrated management server for creative products in cultural arts of FIG. 1;

FIG. 3 is a flow chart illustrating a method for providing an integrated management service for creative products in cultural arts reflecting needs of a requester according to an embodiment of the present invention; and

FIG. 4 is an additional flow chart illustrating a method for providing an integrated management service for creative products in cultural arts reflecting needs of a requester according to an embodiment of the present invention.

### REFERENCE SIGNS LIST

100: Integrated management server for creative products in cultural arts POME storage tank

### DETAILED DESCRIPTION OF THE INVENTION

The creative products in the present invention is a broad concept, which can include a literary work, a musical work, a drama work, an ark work, an architectural work, a photo work, an image work, a geometry work, and a published work etc. More preferably, it refers to the creative products in cultural arts in a narrow sense.

Hereinafter, embodiments of the present invention will be described in detail with reference to accompanying drawings.

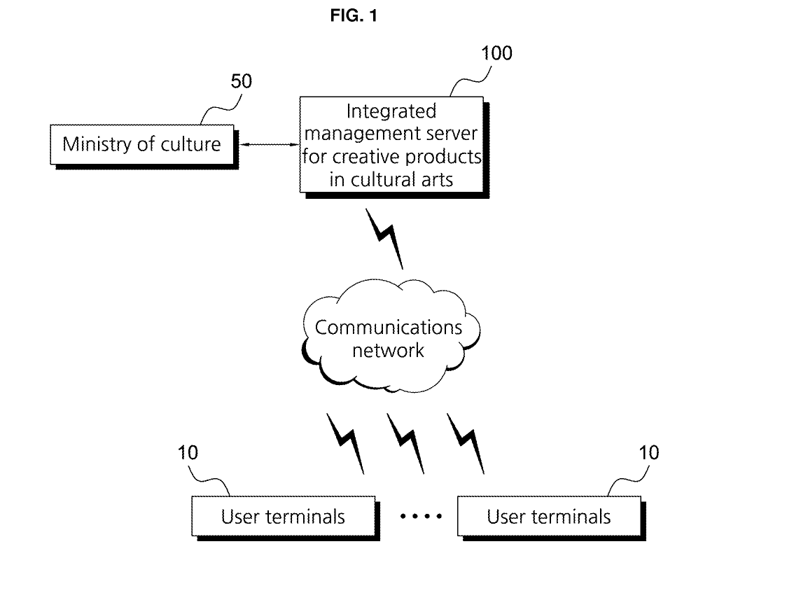

FIG. 1 is a schematic block diagram illustrating a system for applying a method for providing an integrated management service for creative products in cultural arts reflecting needs of a requester according to an embodiment of the present invention.

Referring to FIG. 1, the present invention includes an integrated management server 100 for creative products in cultural arts and user terminals 10. The integrated management server 100 for creative products in cultural arts and the user terminals 10 are connected communicably via a communication network. Here, the network may include a local area network, a wide area network, a wire/wireless communications network, and an internet network etc.

Also, the integrated management server 100 for creative products in cultural arts can perform various cooperation on the implementation of the present invention by connecting with the Ministry of Culture, Sports and Tourism (hereinafter referred to as Ministry of Culture 50), which is the government ministry.

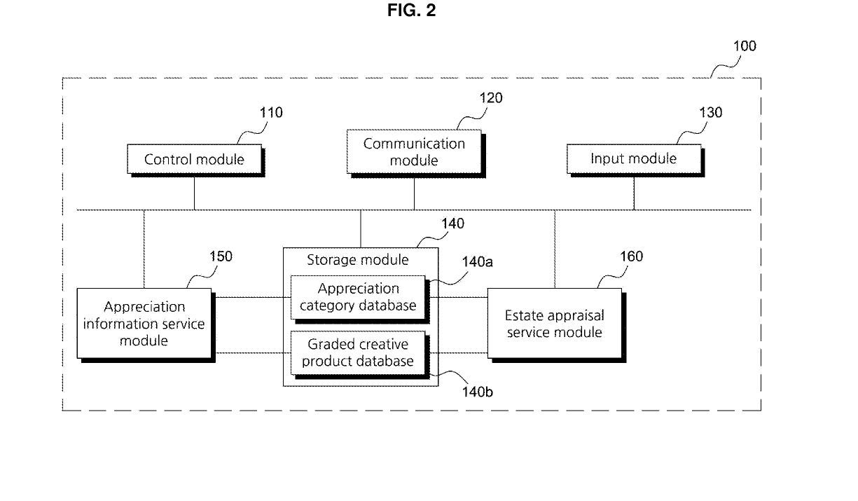

FIG. 2 is a block diagram illustrating a configuration of an integrated management server for creative products in cultural arts of FIG. 1, Referring to FIG. 2, the integrated management server 100 for creative products in cultural arts includes a control module 110, a communication module 120, an input module 130, a storage module 140 including an appreciation category database 140a and a graded creative product database 140b, an appreciation information service module 150, and a estate appraisal service module 160. The appreciation information service module 150 and the estate appraisal service module 160 serve to provide the appreciation information and estate appraisal services reflecting their needs to the customers and can made based on the appreciation category database 140a and the graded creative product database 140b.

The appreciation category database 140a can be configured based on the genres of the historical backdrop of the creative products in cultural arts. Concretely, it can classify the creative products in cultural arts by genre according to the faithful description of the work, the history information, the subjectivity of the artist, the aesthetic plastic theory, and the preference propensity of viewers' needs etc.

The graded creative product database 140b can classify the creative products in cultural arts by creator and creative product level (that is, by classification of value) according to the unique information of the creator and the works. In order to provide an online self-consulting service on the creative products according to one embodiment of the present invention, the graded creative product database 140b should be pre-built.

A creator code information is given to the creator for the pre-build of the graded creative product database 140b. The creator having the creator code number can upload his basic information and creative products to the graded creative product database 140b. After the integrated management server 100 for creative products in cultural arts assigns the creative product identification information on the corresponding creative products based on the uploaded order etc., it can be stored in the graded creative product database 140b. Here, the creators registers his creative products in the integrated management server 100 for creative products in cultural arts, so that it checks the customer's assessment and response information and reflect them in creative activities.

The creator code number and the creative product identification information can be implemented by the unique number, the unique code, the unique identification information, the image pattern, and the bar code on the creator and the creative product. The graded creative product database 140b is constituted on the basis of these creator code numbers and creative product identification information. More particularly, it can be constituted by creator and creative product level (that is, by classification of value) by reflecting various factors such as the creative background or the year of creative product, the activities of the creator, the history information, the survival or age of the creator, the material used in the creative product, the size or the weight of the creative product, the labor time required to complete the creative product, the issue and creativity of the creative product, the production speed of the creative product, the popularity, the rarity, the uniqueness (the degree of similarity works), the sales rate of the creative product, the preference or the evaluation of the appreciator, and the comprehensive evaluation of the expert etc.

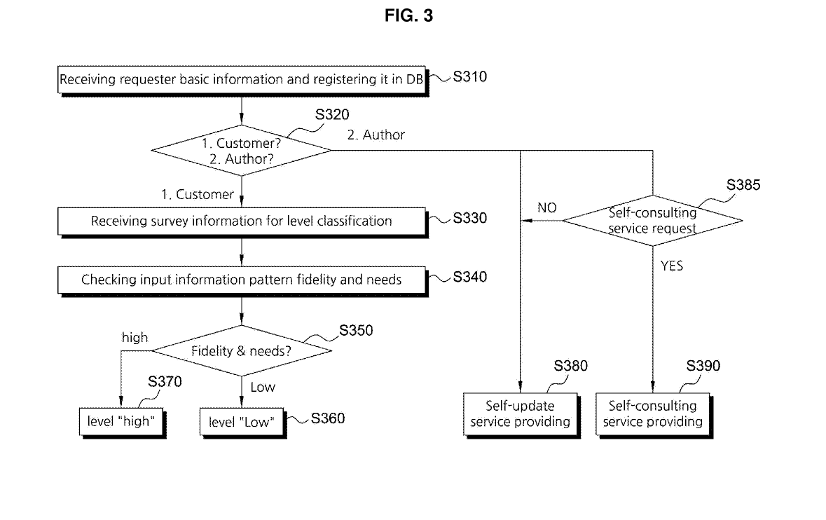

FIG. 3 is a flow chart illustrating a method for providing an integrated management service for creative products in cultural arts reflecting needs of a requester according to an embodiment of the present invention.

First, with respect to the creative product, it can perform the process of registering in the database by providing the basic information of the customer or the author (S310). Here, the customer for providing the basic information may include an appreciator of wanting to appreciate the creative products or a purchaser of wanting the purchase of the creative products. Also, the author for providing the basic information may be the creator of registering his creative products in the integrated management server 100 for creative products in cultural arts so as to checks the customer's assessment and response information and reflect them in creative activities. On the other hand, the basic information of the creator that is, the author is inputted by the creator in the basic information providing step of the step S310, in another embodiment, it may be stored in advance in the graded creative product database 140b as described above.

The basic information registered in the database includes the information on the age, the hobby, the education, the career, and the purpose of the service requester (customer) that is, the appreciator, the purchaser, and the author as the creator, and the customer or the author (S320). That is, in one embodiment of the present invention, the basic information may be the needs information or the membership information as a verification procedure for a kind of level classification so as to provide the appreciation information and estate appraisal service on the creative products in cultural arts according to the embodiment of the present invention and the online self-consulting service on the creative product.

According to one embodiment of the present invention, the users on the appreciation information and estate appraisal service on the creative products in cultural arts according to the embodiment of the present invention and the online self-consulting service on the creative product join to be a member (for example, download or register) through the webpage (not shown) and then, the service according to the present invention can be provided in a login state. Alternatively, in another embodiment, it can provide all or a part of the creative product appreciating service, which is provided in the website of the present invention, to the users who are not joined to be a member as a guest qualification.

First, it will be explained on the service providing method in a case that the customer registered through the inputted basic information is connected to the web page provided by the server 100 according to the present invention.

If the customers according to the present invention is connected to the web page provided by the integrated management server 100 for creative products in cultural arts and appreciate the registered creative products (the login status as a member or guest qualification etc.), the integrated management server 100 for creative products in cultural arts can ask the customers for a survey information associated with a particular creative production capable of checking the needs of the corresponding customer and receive the survey information for level classification from the customers (S330). Here, the survey information may include the needs information that can reflect or check the needs of the customer.

In other words, the customer can respond to the survey information and/or his needs related to the corresponding work including the questions etc. based on his interest level (preference level) on the particular creative products (high/medium/low interest levels (or preference levels), or from 1 to 5 interest levels (or the preference levels etc.), the purpose of using the integrated management service for creative products in cultural arts (that is, the customer's appreciation, purchase, healing or treatment etc.), and a psychology (emotional information).

In case of the service requester (customer) using the present service as a guest in one embodiment of the present invention, the basic information that is, the age, the hobby, the education, the career, and the purpose of the service requester, the customer or the author, and the needs of the corresponding customer etc. can be requested separately.

If the basic information having the reflected needs of the corresponding customer and the survey information related to the particular creative product are inputted from the customer, the integrated management server 100 for creative products in cultural arts can perform a check of the input information pattern fidelity and needs (S340). In one embodiment, by analyzing the response level of the provided information, it can determine whether it has the fidelity or not. For example, by considering the check of the correct input for each item, the check of missing items, the check of the number of the missing items, the check of the interest level, and the needs of the corresponding customer etc., it can perform the check of the input information pattern fidelity and needs.

When the integrated management server 100 for creative products in cultural arts has been performed the check of the input information pattern fidelity and needs on the input information pattern (S350), if the fidelity and needs levels of the input information are low, the corresponding customer is classified as a “level low” in the integrated management server 100 (S360). Alternatively, if the fidelity and needs levels of the input information are high, the corresponding customer is classified as a “level high” in the integrated management server 100 (S365). On the other hand, although it is not shown in the drawings, (i) if the fidelity level of the input information is low and the needs level of the input information is high, or (ii) if the fidelity level of the input information is high and the needs level of the input information is low, the corresponding customer is classified as a “level middle” in the integrated management server 100.

That is, the integrated management server 100 for creative products in cultural arts analyzes the survey and needs information related to the input basic information and the corresponding work and classifies the corresponding customer level into “high”, “middle”, and “low” to be updated in the database. At this time, the identification information of the creative products and the code number of the creator are matched with each other to be updated together. the identification information of the corresponding creative product means an unique identification number, an unique code, an unique image pattern, and a bar code (QR code) etc. capable of identifying the corresponding creative product, whereby it is possible to identify the genre and the nationality etc. of the creator and the creative product.

Continuously, it will be explained on the service providing method in a case that the creator that is, the author registered through the inputted basic information is connected to the web page provided by the server 100 according to the present invention.

In case of the author, the self-update service on the creative product of the corresponding author is provided to the author (S380). Specifically, the introduction of particular creative product and the writing for communicating with the customer can be inputted from the author. In addition, the function capable of self-updating his information by means of the creator may be added. Also, in the self-updating service, the author himself can determine that it uploads the new creative product or additional product or delete the existing product from the database through the self-update service, the author introduces his creative products to the customers, is communicated with the customers, and reflect the needs of the customers on their creative activities later.

In addition, where the author requests the online self-consulting service on his creative product (S385: Yes), in response to the request, the integrated management server 100 for creative products in cultural arts provides the online self-consulting service to the corresponding author (S390). In this case, the customer's preferences and needs on the corresponding creative product and the visit record of the customer etc. can be reflected and provided through the self-consulting information for author. Also, only the creator may be authorized to access on the self-consulting information.

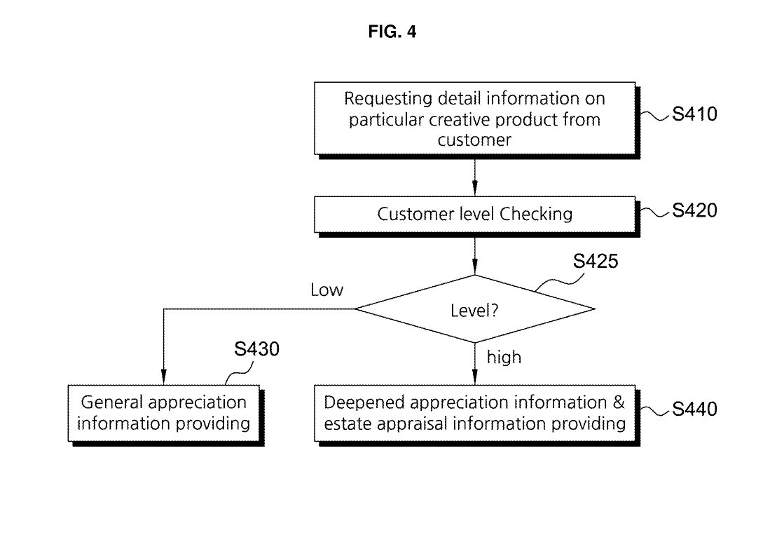

FIG. 4 is an additional flow chart illustrating a method for providing an integrated management service for creative products in cultural arts reflecting needs of a requester according to an embodiment of the present invention.

Referring to FIG. 4, after the level of the customer is classified in FIG. 3, if the customer will request the detail information on the particular creative product later, for example, if the request on the appreciation information or the estate appraisal information is existed (S410), the customer level stored in the database is checked (S420), the information according to each level can be selectively provided to the corresponding customer. In this case, the detail information on the particular creative product can be requested from the user terminal 10 of the customer communicably connected to the integrated management server 100 for creative products in cultural arts via a communication network. At this time, when the identification information of the creative product is implemented as a QR code or a bar code or the like, the user terminal of the customer has an additional function for recognizing the identification information or is required to install the additional function.

In one embodiment, as a result of the level check of the corresponding customer (S425), only the general appreciation information is provided to the customers classified as the “level low” (S430). Furthermore, in this embodiment, the estate appraisal information is not provided to the customers classified as the “level low”. However, if it takes a policy of providing the estate appraisal information to the customers classified as the “level low”, the customers classified as the “level low” also can provide the estate appraisal information.

In this embodiment, the general appreciation information can include the data stored in the appreciation category database 140a and the information on a basic history information, a basic work explanation, a basic plastic theory, an introduction of the same author on the other work, and a subjectivity of the appreciator etc. on the corresponding creative product, based on the accumulated work recognition information of the corresponding creative product. In addition, this general appreciation information can include the information directly updated by the author of the corresponding creative product, for example the introduction on the creative product directly written by the corresponding author and the writing directly written for communicating with the customer.

In the meantime, as a result of the level check of the corresponding customer (S425), the deepened appreciation information and the estate appraisal information are provided to the customers classified as the “level high” (S440). Also, the healing information may be provided in accordance with the policies of the integrated management service for creative products in cultural arts according to the embodiment of the present invention. The deepened appreciation information includes the information such as the in-depth history information about the corresponding creative product, the work description, the aesthetic plastic theory, the introduction of the same author on the other work, and the subjectivity of the appreciator etc. based on the unique information of the corresponding creative product stored in the graded creative product database 140b. It contains more detailed information than the general appreciation information.

The estate appraisal information can provide the creative background or the year of the corresponding creative product stored in the graded creative product database 140b, the activities of the creator, the history information, the survival or age of the creator, the material used in the creative product, the size or the weight of the creative product, the labor time required to complete the creative product, the issue and creativity of the creative product, the production speed of the creative product, the popularity, the rarity, the uniqueness (the degree of similarity works), the sales rate of the corresponding creative product according to the integrated management service for creative products according to the present invention, the comprehensive evaluation of the estate appraisal of the expert based on the assessment or the response of the appreciator, and the price information of the creative products necessary for the work deal.

In one embodiment, the comprehensive evaluation of the estate appraisal is classified into three sections for the purpose of the proper selling/buying time and the enjoyment so as to buy cheaply undervalued creative products and sell over market sell when the value has been increased in the future depending on the needs of the buyers. That is, it is classified into 1. Standard type, 2. Investment value type, and 3. Holding value type. In case of 1. Standard type, it can provide the estate appraisal information with a view to trade, that is buy it for the enjoyment of the corresponding creative product. In case of 2. Investment value type, it can provide the estate appraisal information for the purposes of the expected return on investment such as bid/public sale/auction etc. so as to avoid transient fads seen outwardly. Also, in case of 3. Holding value type, it evaluates the enjoyment value for self-realization and the future value of the corresponding work owned by the individuals, the organizations, the institutions, and the public facilities etc. through the analysis of the price trend and the current status of the work and the analysis of the activity trends of the authors, so that it can provide the analysis materials capable of determining the disposal and sale period together.

On the other hand, although it is not shown in the drawings, the service of various methods can be provided to the customers classified as the “level middle” in accordance with the policies of the integrated management service for creative products in cultural arts according to the embodiment of the present invention. For example, the customers classified as the “level middle” can be equally with the customers classified as the “level low” described above. Alternatively, the customers classified as the “level middle” can be equally with the customers classified as the “level high” described above. In another embodiment, any one of the general appreciation information provided to the customers classified as the “level low” described above and the deepened appreciation information provided to the customers classified as the “level high” described above can be provided to the customers classified as the “level middle”.

In an embodiment of the invention, it can provide the appreciation information and the work recognition accumulated for the creative products, the preference of the appreciators, and the information of the visitors regarding the sales of the corresponding creative product. Here, this information may be visually and/or acoustically supported. Also, it can provide the function capable of confirming the comprehensive information about the customers of appreciating the creative product to the creator himself. By providing such consulting services for the creator, the creator can reflect it in future according to the understanding of the preference of the appreciator or the buyer for his work and the need information thereof.

In addition, after the preferences and the needs information accumulated by the plurality of the appreciators are stored in the database, it analyzes the past visiting information such as the past appreciation information and estate appraisal information during the access of the DB information again, so that the user can obtain the past preferences of the appreciators, thereby increasing the usability thereof. For example, when the user gains newly access to the appreciation information, the past appreciation information of the appreciators can be automatically provided without the additional request of the appreciators or the past appreciation information having high preference can be automatically extracted and provided by analyzing the accumulated appreciation information.

Also, after the psychological state of the appreciator is caught by analyzing the accumulated preference or needs information, it is also possible to provide the appreciating treatment information capable of healing the caught psychological state. For example, as a result of the analysis of the accumulated survey information and preferences or the needs information, if the psychological state or the emotional state of the appreciator is considered to be depressed or uneasy, images or color art creations capable of treating or mitigating the uneasiness mind are extracted to be provided or music creations capable of feeling homogeneous rhythm or tempo can be provided together.

In the above described embodiment, in order to provide the integrated management service for creative products in cultural arts, it was explained around the online integrated management server. However, in another embodiment of the present invention, it can also provide the integrated management service for creative products in cultural arts through the interaction between the online system and the offline system. More specifically, the creative product identification information to an embodiment of the present invention may be implemented as the bar code or the QR code printed on the details on an entry of the offline exhibition, the published pamphlet in offline, the promotional literature, and the publications etc. The creative product identification information printed on these printed matters is read through the requester's mobile terminal, so that it is possible to access the database of the integrated management server 100 for creative products in cultural arts.

Although the invention has been described according to the preferred embodiment mentioned above, the invention can be variously changed and modified without deviating from the essential point and scope of the invention. Accordingly, the accompanying Claims include such change and modification belonging to the essential point of the invention.

What is claimed is:

1. A method for providing an integrated management service for creative products in cultural arts reflecting needs of a requester comprising the steps of:
(i) receiving, as an input, basic information and survey information in which the needs of the requester are reflected, from the requester who has appreciated or is to appreciate a particular creative product;
(ii) classifying a level of the requester on the basis of the needs of the requester included in the input basic information and survey information, and registering a result of the classification in a database together with the basic information, the survey information, and creative product identification information on the creative product; and
(iii) providing a selective and limited service according to the classified level of the requester, when the requester requests detailed information on the particular creative product.

2. The method as claimed in claim 1, further comprising steps of:
constituting a graded creative product database by giving a creator code information to the creator of the creative product, assigning the creative product identification information on the corresponding creative product, and storing them in a database.

3. The method as claimed in claim 2, wherein the creator code number is an information for identifying the creator and another creator and the creative product identification information is an information for identifying the corresponding creative product and the other creative product, the creator code number and the creative product identification information including an unique number, an unique code, an unique identification information, an image pattern, and a bar code.

4. The method as claimed in claim 2, wherein the graded creative product database is classified and constituted by level according to a background or an year of the creative product, activities of the creator, a history information, a survival or age of the creator, a material used in the creative product, a size or a weight of the creative product, a labor time required to complete the creative product, an issue and creativity of the creative product, a production speed of the creative product, a popularity, a rarity, an uniqueness (degree of similarity works), a sales rate of the creative product, a preference or an evaluation of the appreciator, and a comprehensive evaluation of the expert etc.

5. The method as claimed in claim 1, further comprising steps of:
performing (i) step through (iii) step repeatedly; and
providing a visiting history of reflecting assessments or needs of the requesters accumulated by the repeated steps by linking with the a self-consulting information for creator.

6. The method as claimed in claim 1, wherein, where a level of the requester is a “level low”, the selective and limited service is a service of providing only the appreciation information to the requester.

7. The method as claimed in claim 1, wherein, where a level of the requester is a “level high”, the selective and limited service is a service of providing at least one of an appreciation information on the creative product, an estate appraisal information on the creative product, and an appreciating treatment information.

8. The method as claimed in claim 7, wherein the appreciating treatment information is an information for healing the caught psychological/emotional state after the psychological/emotional state of the appreciator is caught by analyzing the accumulated preference or needs information.

9. The method as claimed in claim 7, wherein the estate appraisal information is any one of (1) standard type estate appraisal information, (2) investment value type estate appraisal information, and (3) holding value type estate appraisal information for the purpose of the proper selling/buying time and the enjoyment so as to buy cheaply undervalued creative products and sell over market sell when the value has been increased in the future depending on the needs of the requesters.

10. The method as claimed in claim 1, wherein a survey information related to the creative products comprises an information related to an interest, a purpose, and a preference level on the creative products and an information of reflecting the needs of the requester who has appreciated or is to appreciate the creative product.

11. The method as claimed in claim 1, further comprising steps of:
providing a self-consulting service so as to reflect the information of reflecting the assessments and the needs of the requester accumulated in the database in his work production, if a service is requested from an author of creating the particular creative product.

12. The method as claimed in claim 11 further comprising steps of:
providing an updated database to the requester by updating contents or new information directly updated by the creator in the database by means of the self-consulting service provided to the creator.
